(19) United States
(12) Patent Application Publication
(10) Pub. No.: US 2022/0188128 A1
(43) Pub. Date: Jun. 16, 2022

(54) TELEMETRY-BASED PRELOADING FOR A USER INTERFACE

(71) Applicant: VMware, Inc., Palo Alto, CA (US)

(72) Inventors: Branislav Abadzhimarinov, Sofia (BG); Vasil Chomakov, Sofia (BG)

(73) Assignee: VMware, Inc., Palo Alto, CA (US)

(21) Appl. No.: 17/119,097

(22) Filed: Dec. 11, 2020

(51) Int. Cl. G06F 9/451

(52) U.S. Cl. CPC G06F 9/451

(57) ABSTRACT

The present disclosure is related to methods, systems, and machine-readable media for telemetry-based preloading. A plurality of telemetry events corresponding to a plurality of sessions with an application can be received, wherein each telemetry event is associated with a user selection of any of a plurality of user interface elements of the application that causes one of a plurality of chunks of executable instructions of the application to load. A respective probability associated with each of the plurality of chunks being loaded in a subsequent session can be determined, and the plurality of chunks can be preloaded during an idle period of the subsequent session in an order of descending determined probability.

### BACKGROUND

Applications (e.g., web applications) can include user interfaces. User interfaces can provide content, such as display elements. Some interfaces may include an amount of content that makes loading such interfaces time consuming. Users may experience frustration by delays.

Some previous approaches to providing content through user interfaces may delay the loading of content until it becomes visible in the user interface. However, if a user desires to perform an action that causes something (e.g., a file) to be downloaded, the action may be delayed until that download and processing is completed. This delay may be increased in high latency, low bandwidth environments.

### BRIEF DESCRIPTION OF THE DRAWINGS

FIG. 1 is a diagram of a host and a system for telemetry-based preloading for a user interface according to one or more embodiments of the present disclosure.

FIG. 2A is a first display of an example interface associated with telemetry-based preloading for a user interface according to one or more embodiments of the present disclosure.

FIG. 2B is a second display of the example interface associated with telemetry-based preloading for a user interface according to one or more embodiments of the present disclosure.

FIG. 3 is a diagram of a system for telemetry-based preloading for a user interface according to one or more embodiments of the present disclosure.

FIG. 4 is a diagram of a machine for telemetry-based preloading for a user interface according to one or more embodiments of the present disclosure.

### DETAILED DESCRIPTION

Embodiments of the present disclosure provide telemetry-based preloading for a user interface. One embodiment, for instance, includes receiving a plurality of telemetry events corresponding to a plurality of sessions with an application, wherein each telemetry event is associated with a user selection of any of a plurality of user interface elements of the application that causes one of a plurality of chunks of executable instructions of the application to load, determining, based on the plurality of telemetry events, a respective probability associated with each of the plurality of chunks being loaded in a subsequent session, and preloading the plurality of chunks during an idle period of the subsequent session in an order of descending determined probability.

While previous approaches to loading single-page user interface applications may employ “lazy loading” of executable instructions (sometimes referred to herein as “code”) to speed up initial application load time and reduce script processing/execution in runtime, these approaches have shortcomings. For example, when a user performs an action that causes a JavaScript file to be downloaded, the action may be delayed until the file is actually downloaded and processed by the user's browser. This delay may be frustrating, especially in environments with high latency and/or low bandwidth. Some users may navigate away from the application altogether assuming it to be nonresponsive.

Some previous approaches to providing content through user interfaces may delay the loading of executable instructions until display elements associated therewith become visible in the user interface. In an example, the process of scrolling down an application reveals previously unseen display elements, causing the executable instructions associated therewith to then be loaded. These approaches may be inadequate, particularly in user interfaces that have an index, inventory, and/or navigation pane where a great deal of display element content is immediately visible and/or commonly visible. It is noted that while the example of a graphical user interface (e.g., a screen) is discussed herein, embodiments of the present disclosure are not so limited. Telemetry-based preloading can be utilized in other user interfaces where preloading is desired.

The present disclosure takes advantage of user idle periods to preload code in an order that increases the likelihood that when the user needs something it is already loaded and ready for them. The order in which code is loaded can be determined based on historical interactions with the application. Stated differently, embodiments herein can determine which user interface elements—and thus which chunks of code—users commonly interact with. This information can allow ordering of the chunks of code in terms of probability of being loaded in a given session. A chunk of code, sometimes referred to herein simply as “chunk” refers to a portion of code associated with a web application. A chunk can refer to static resources rather than time-dependent resources. A chunk can refer to code rather than data. A chunk can be a file. For example, a chunk can be a JavaScript file. A chunk can correspond to a portion of a display and/or interface. For example, a chunk can correspond to a dialog box. A chunk can correspond to a wizard or setup assistant. A chunk can correspond to an object (e.g., a virtual object). For example, a chunk can correspond to an object of a software defined data center.

Over a plurality of sessions (e.g., thousands of sessions involving thousands of users), user interactions with the user interface can trigger telemetry events. Telemetry generally refers the in situ collection of measurements or other data at remote points and their automatic transmission to receiving equipment for monitoring. Each instance of a chunk being loaded can cause a telemetry event to be sent back to the server (e.g., the server hosting the application). A telemetry event describes which chunk was loaded and can include other information, such as a time the chunk was loaded, a user identifier, etc. These telemetry events can be received and examined to determine the respective quantity or proportion of interactions with each user interface element. The chunks can be ordered in terms of a probability of being loaded in a given subsequent session.

During the subsequent session, embodiments herein can determine when a user is idle. User idleness can be determined in any suitable matter known to those of skill in the art. Once the user is idle, embodiments herein can initiate a preloading process. The preloading process includes preloading the plurality of chunks in an order of descending determined probability. Stated differently, the chunks can be loaded beginning with a chunk having a first (e.g., highest) probability of being loaded, followed by a chunk having a second (e.g., second highest) probability of being loaded, followed by a chunk having a third (e.g., third highest) probability of being loaded, and so on. In some embodiments the preloading process is completed when all of the plurality of chunks are loaded. In other embodiments, the preloading process is completed when less than all of the plurality of chunks are loaded. The preloading process can be completed during a single idle period in some cases. In other cases, the process is stopped when the idle period ends (e.g., the user resumes interaction with the application) and can be completed during one or more subsequent idle periods.

Accordingly, embodiments herein can increase the likelihood that when a user desires some application content, that content is already loaded and ready. As a result, embodiments of the present disclosure improve the performance of the user interface and the application provided thereby.

The term “virtual computing instance” (VCI) refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

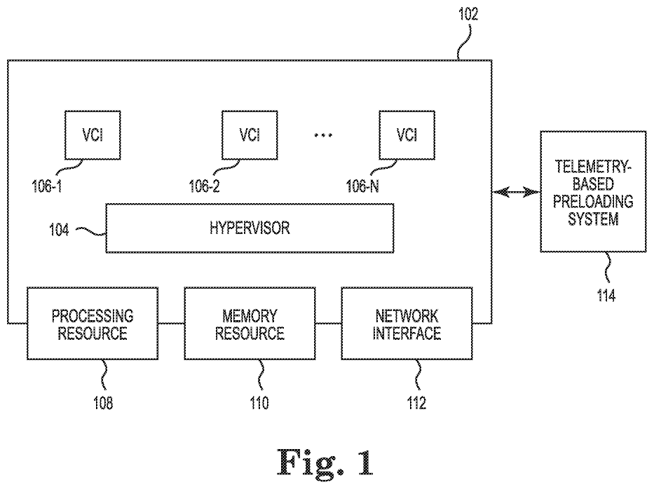

As used herein with respect to VCIs, a “disk” is a representation of memory resources (e.g., memory resources 110 illustrated in FIG. 1) that are used by a VCI. As used herein, “memory resource” includes primary storage (e.g., cache memory, registers, and/or main memory such as random access memory (RAM)) and secondary or other storage (e.g., mass storage such as hard drives, solid state drives, removable media, etc., which may include non-volatile memory). The term “disk” does not imply a single physical memory device. Rather, “disk” implies a portion of memory resources that are being used by a VCI, regardless of how many physical devices provide the memory resources.

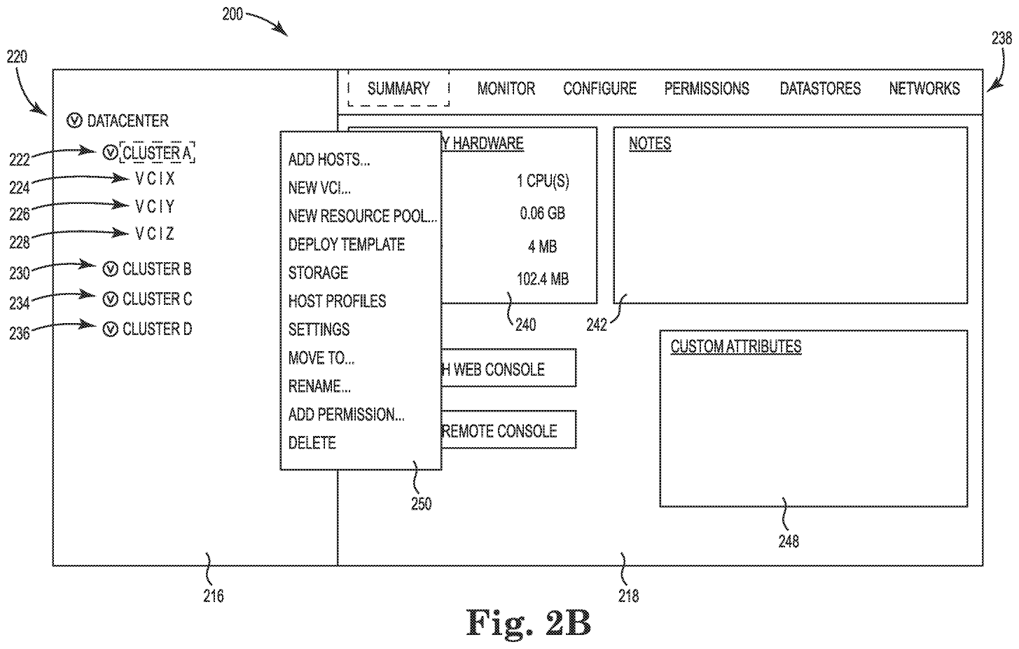

The figures herein follow a numbering convention in which the first digit or digits correspond to the drawing figure number and the remaining digits identify an element or component in the drawing. Similar elements or components between different figures may be identified by the use of similar digits. For example, 114 may reference element “14” in FIG. 1, and a similar element may be referenced as 314 in FIG. 3. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present disclosure, and should not be taken in a limiting sense.

FIG. 1 is a diagram of a host and a system for telemetry-based preloading for a user interface according to one or more embodiments of the present disclosure. The system can include a host 102 with processing resources 108 (e.g., a number of processors), memory resources 110, and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of virtual computing instances 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs can be local and/or remote to the host 102. For example, in a software defined data center, the VCIs 106 can be provisioned with resources that are generally available to the software defined data center and not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. The host 102 can be in communication with a telemetry-based preloading system 114. An example of the telemetry-based preloading system is illustrated and described in more detail below. In some embodiments, the telemetry-based preloading system 114 can be a server, such as a web server.

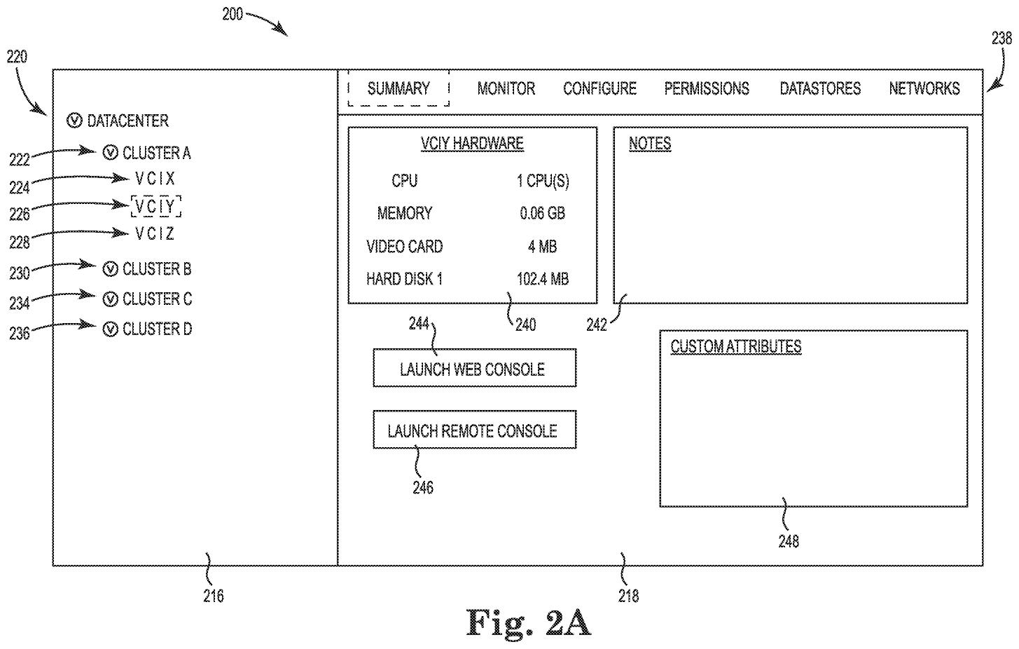

FIG. 2A is a first display of an example interface 200 associated with telemetry-based preloading for a user interface according to one or more embodiments of the present disclosure. FIG. 2B is a second display of the example interface 200 associated with telemetry-based preloading for a user interface according to one or more embodiments of the present disclosure. FIGS. 2A and 2B may be cumulatively referred to herein as “FIG. 2.”

The interface 200 can be a web application. As shown in FIG. 2, the interface 200 can be a web application for managing installations and/or handling virtual objects in a virtualized environment. The interface 200 is provided as an example and it is noted that embodiments herein are not limited to the example interface, or type of interface, illustrated in FIG. 2.

The interface 200 can include a navigation pane 216 and a details pane 218. The navigation pane 216 and the details pane 218 can each include one or more user interface elements. A user interface element can refer to a display element of a graphical user interface (GUI). Display elements are known to those of skill in the art and can include, for example, hyperlinks, buttons, icons, menus, windows, panes, etc. While the example of a display is discussed herein, it is noted that embodiments of the present disclosure include other types of user interfaces. For example, a voice user interface (VUI) may utilize audio elements instead of display elements. Thus, where the more specific term “display element” is used herein, it is noted that such reference refers to the example of a GUI.

As shown in the example illustrated in FIG. 2, the navigation pane 216 includes eight display elements: a datacenter element 220, a cluster A element 222, a VCIX element 224, a VCIY element 226, a VCIZ element 228, a cluster B element 230, a cluster C element 234, and a cluster D element 236. Selection of one of the display elements in the navigation pane 216 can cause information corresponding to the selected display element to be displayed in the details pane 218. In the example illustrated in FIG. 2A, the VCIY element 226 has been selected and details corresponding to VCIY are displayed by the details pane 218.

The details pane 218 can include a plurality of display elements. As shown in the example illustrated in FIG. 2A, the details pane can include a plurality of tabs 238. Each of the tabs 238 can be selected to display, in the details pane 218, a particular type of information regarding the selected element. As shown in the example illustrated in FIG. 2A, the “summary” tab is selected and, as a result, the details pane 218 includes display elements corresponding to summary information regarding VCIY. The summary information is displayed in the example shown in FIG. 2A by a plurality of display elements including a hardware window 240, a notes window 242, and a custom attributes window 248. In addition, the details pane includes a “launch web console” button 244 and a “launch remote console” button 246. Selection of any of the other tabs 238 (e.g., “monitor,” “configure,” “permissions,” “datastores,” and/or “networks”) causes display elements corresponding to such information to be included in the details pane 218. It is noted that embodiments of the present disclosure are not limited to the types, the arrangement, and/or the contents of interfaces or display elements illustrated herein.

Selection of a display element, as known to those of skill in the art, can be carried out in any suitable manner. In some embodiments, for instance, a display element is selected using a short press on a touch-screen display (e.g., on a mobile device). In some embodiments, a display element is selected using an input/output device (e.g., a mouse). For example, a display element can be selected by actuating a first (e.g., left) mouse button. In some embodiments, selection of a display element includes a long press on a touch-screen display. In some embodiments, selection of a display element includes “hovering” over a display element using a pointing device (e.g., a mouse cursor). In some embodiments, selection of a display element includes actuating a second (e.g., right) mouse button.

FIG. 2B illustrates a second display of the example interface 200 after a “right click” on the cluster A element 222. A “right click” may cause the loading of a different portion of the display. For instance, a dialog box 250 corresponding to cluster A can be displayed responsive to the right clicking on the cluster A element 222. The dialog box 250 can itself include a plurality of display elements. Embodiments of the present disclosure do not limit the types of dialog box display elements. Some example dialog box display elements can include elements corresponding to settings, preferences, permissions, profiles, etc.

Though FIG. 2 illustrates examples of some particular types of display elements, it is noted that a “display element,” or, more generally, a “user interface element,” as referred to herein, is a portion of a user interface of a web application. In accordance with the present disclosure, executable instructions of a web application can be separated into a plurality of chunks, each chunk corresponding to a respective display element. For instance, as illustrated in FIG. 2A, selection of the VCIY element 226 causes the loading of a chunk of executable instructions corresponding to the display of the details pane 218. Similarly, as illustrated in FIG. 2B, “right-clicking” on the cluster A element 222 causes the loading of a different chunk of executable instructions corresponding to the display of the dialog box 250. Chunks can include files. For example, a chunk can be a JavaScript file. As previously discussed, a chunk can correspond to a window, a hyperlink, a button, a tab, and/or a dialog box. A chunk can correspond to a wizard or setup assistant. A chunk can correspond to an object (e.g., a virtual object). For example, a chunk can correspond to an object of a software defined data center.

As discussed further below, as a user interacts with display elements and causes chunks to load, telemetry events can be sent to a server, such as the telemetry-based preloading system 114, previously described in connection with FIG. 1. These events, across multiple users, can inform the determination of which chunks are interacted with most often, and therefore which chunks should be prioritized in preloading.

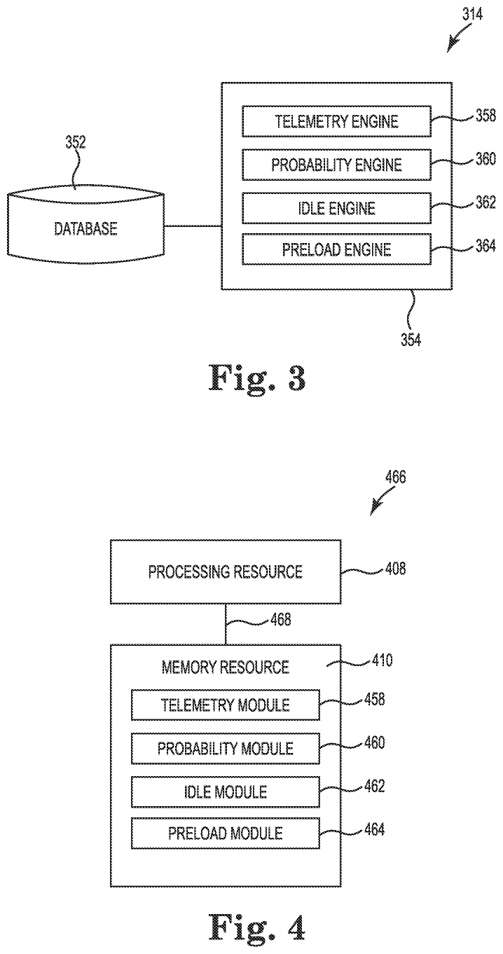

FIG. 3 is a diagram of a system 314 for telemetry-based preloading for a user interface according to one or more embodiments of the present disclosure. The system 314 can include a database 352, a subsystem 354, and/or a number of engines, for example, telemetry engine 358, probability engine 360, idle engine 362, and/or preload engine 364, and can be in communication with the database 352 via a communication link. The system 314 can include additional or fewer engines than illustrated to perform the various functions described herein. The system can represent program instructions and/or hardware of a machine (e.g., machine 466 as referenced in FIG. 4, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the telemetry engine 358 can include a combination of hardware and program instructions that is configured to receive a plurality of telemetry events corresponding to a plurality of sessions with an application, wherein each telemetry event is associated with a user selection of any of a plurality of user interface elements of the application that causes one of a plurality of chunks of executable instructions of the application to load. User selections, such as clicks, hovers, selections, right clicks, etc. can cause telemetry events to be communicated (e.g., to a server).

In some embodiments, the probability engine 360 can include a combination of hardware and program instructions that is configured to determine, based on the plurality of telemetry events, a respective probability associated with each of the plurality of chunks being loaded in a subsequent session. In some embodiments, the probabilities can correspond to a quantity of interactions with each of the user interface elements over a particular time period. In some embodiments, the probabilities can correspond to a proportion of total interactions with particular user interface elements.

In some embodiments, the idle engine 362 can include a combination of hardware and program instructions that is configured to determine an idle period during the subsequent session. Embodiments of the present disclosure can determine an idle period in a variety of manners. For instance, determining an idle period can include determining that a particular period of time has elapsed during which the user has not interacted with any user interface elements. Determining an idle period can include determining that a particular period of time has elapsed during which no inputs were received from an input/output device (e.g., a mouse, touch-screen display, and/or keyboard).

In some embodiments, the preload engine 364 can include a combination of hardware and program instructions that is configured to initiate a preload process during the idle period, wherein the preload process includes preloading the plurality of chunks in an order of descending determined probability. In some embodiments, the plurality of chunks are loaded, beginning with a chunk having a highest determined probability and the loading continues in descending order until all of the plurality of chunks have been loaded.

Some embodiments include a connection engine configured to determine a type of a connection associated with the subsequent session. Depending on the connection, the preload process may be carried out or may not be carried out. For instance, in some embodiments, the preload process is not initiated if a connection speed does not exceed a speed threshold. In some embodiments, the preload process is initiated responsive to a determination that the connection speed does exceed the speed threshold. Connection speed may be related to a user device type. In some embodiments, the preload process is initiated responsive to a determination that the user is using a first device type (e.g., a desktop computer) and may not be initiated responsive to a determination that the user is using a second device type (e.g., a phone).

FIG. 4 is a diagram of a machine for telemetry-based preloading for a user interface according to one or more embodiments of the present disclosure. The machine 466 can utilize software, hardware, firmware, and/or logic to perform a number of functions. The machine 466 can be a combination of hardware and program instructions configured to perform a number of functions (e.g., actions). The hardware, for example, can include a number of processing resources 408 and a number of memory resources 410, such as a machine-readable medium (MRM) or other memory resources 410. The memory resources 410 can be internal and/or external to the machine 466 (e.g., the machine 466 can include internal memory resources and have access to external memory resources). In some embodiments, the machine 466 can be a VCI. The program instructions (e.g., machine-readable instructions (MM)) can include instructions stored on the MRM to implement a particular function (e.g., an action such as creating a live snapshot at an end of a snapshot chain, as described herein). The set of MRI can be executable by one or more of the processing resources 408. The memory resources 410 can be coupled to the machine 466 in a wired and/or wireless manner. For example, the memory resources 410 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 410 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 408 can be coupled to the memory resources 410 via a communication path 468. The communication path 468 can be local or remote to the machine 466. Examples of a local communication path 468 can include an electronic bus internal to a machine, where the memory resources 410 are in communication with the processing resources 408 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 468 can be such that the memory resources 410 are remote from the processing resources 408, such as in a network connection between the memory resources 410 and the processing resources 408. That is, the communication path 468 can be a network connection. Examples of such a network connection can include a local area network (LAN), wide area network (WAN), personal area network (PAN), and the Internet, among others.

As shown in FIG. 4, the MRI stored in the memory resources 410 can be segmented into a number of modules 458, 460, 462, 464 that when executed by the processing resources 408 can perform a number of functions. As used herein a module includes a set of instructions included to perform a particular task or action. The number of modules 458, 460, 462, 464 can be sub-modules of other modules. For example, the preload module 464 can be a sub-module of the idle module 462 and/or can be contained within a single module. Furthermore, the number of modules 458, 460, 462, 464 can comprise individual modules separate and distinct from one another. Examples are not limited to the specific modules 458, 460, 462, 464 illustrated in FIG. 4.

Each of the number of modules 458, 460, 462, 464 can include program instructions and/or a combination of hardware and program instructions that, when executed by a processing resource 408, can function as a corresponding engine as described with respect to FIG. 3. For example, the preload module 464 can include program instructions and/or a combination of hardware and program instructions that, when executed by a processing resource 408, can function as the preload engine 364, though embodiments of the present disclosure are not so limited.

The machine 466 can include a telemetry module 458, which can include instructions to receive a plurality of telemetry events corresponding to a plurality of sessions with an application, wherein each telemetry event is associated with a user selection of any of a plurality of user interface elements of the application that causes one of a plurality of chunks of executable instructions of the application to load. The machine 466 can include a probability module 460, which can include instructions to determine, based on the plurality of telemetry events, a respective probability associated with each of the plurality of chunks being loaded in a subsequent session. The machine 466 can include an idle module 462, which can include instructions to determine an idle period during the subsequent session. The machine 466 can include a preload module 464, which can include instructions to initiate a preload process during the idle period, wherein the preload process includes preloading the plurality of chunks in an order of descending determined probability.

In some embodiments, the preload process is completed during the idle period. In other embodiments, the preload process is stopped responsive to a determination that the idle period has ended (e.g., the user re-engages with the web application). Once stopped, the preload process can be resumed responsive to a determination of a subsequent idle period during the subsequent session. The preload process may be completed during the subsequent session, or during another subsequent session.

Referring back to FIG. 2, it is noted that the navigation pane 216 may be perpetually visible in the display 200. Preloading chunks associated with display elements in the navigation pane (or any other visible display elements) may be delayed until an idle condition even when those elements are visible. As a result, the user's interaction with the web application may be unhindered by preloading until they are idle. If, for example, the order of descending determined probability associated with the interface 200 began with cluster A element 222, followed by VCIY element 226, followed by “launch web console” button 244, the preload process may begin by preloading the chunks associated with cluster A element 222, followed by VCIY element 226, followed by “launch web console” button 244.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method, comprising:
receiving a plurality of telemetry events corresponding to a plurality of sessions with an application, wherein the application includes a perpetually visible navigation pane that includes a plurality of user interface elements, and a details pane configured to display information corresponding to a selected one of the plurality of user interface elements of the navigation pane, wherein each telemetry event is associated with a user selection of any of the plurality of user interface elements of the navigation pane that causes one of a plurality of chunks of executable instructions of the application to load;
determining, based on the plurality of telemetry events, a respective probability associated with each of the plurality of chunks being loaded in a subsequent session; and
initiate a preload process during an idle period of the subsequent session, wherein the preload process includes preloading all of the plurality of chunks of executable instructions of the application in an order of descending determined probability irrespective of whether any of the plurality of user interface elements are currently visible on a display device.

2. The method of claim 1, wherein determining the respective probability associated with each of the plurality of chunks being loaded in the subsequent session includes determining, from the plurality of telemetry events, a quantity of selections of each of the plurality of user interface elements.

3. The method of claim 1, wherein the method includes receiving one of the plurality of telemetry events responsive to a first type of selection of a particular user interface element.

4. The method of claim 1, wherein the method includes receiving one of the plurality of telemetry events responsive to a second type of selection of one of the plurality of user interface elements.

5. The method of claim 1, wherein the method includes collecting the plurality of telemetry events over the plurality of sessions with the application.

6. The method of claim 1, wherein the method includes preloading the plurality of chunks during the idle period of the subsequent session responsive to a determination that a user device type associated with the subsequent session exceeds a speed threshold.

7. The method of claim 6, wherein the method includes:
receiving the plurality of telemetry events corresponding to the plurality of sessions with the application, wherein each telemetry event is associated with a user selection of any of a plurality of display elements visually displayed by a display device that causes one of a plurality of chunks of executable instructions of the application to load; and
preloading the plurality of chunks during the idle period of the subsequent session in the order of descending determined probability while the plurality of display elements are visually displayed by the display device.

8. A non-transitory machine-readable medium having instructions stored thereon which, when executed by a processor, cause the processor to:
receive a plurality of telemetry events corresponding to a plurality of sessions with an application, wherein the application includes a perpetually visible navigation pane that includes a plurality of user interface elements, and a details pane configured to display information corresponding to a selected one of the plurality of user interface elements of the navigation pane, wherein each telemetry event is associated with a user selection of any of the plurality of user interface elements of the navigation pane that causes one of a plurality of chunks of executable instructions of the application to load;
determine, based on the plurality of telemetry events, a respective probability associated with each of the plurality of chunks being loaded in a subsequent session;
detect an idle period during the subsequent session; and
initiate a preload process during the idle period, wherein the preload process includes preloading all of the plurality of chunks of executable instructions of the application in an order of descending determined probability irrespective of whether any of the plurality of user interface elements are currently visible on a display device.

9. The medium of claim 8, including instructions to complete the preload process during the idle period.

10. The medium of claim 8, including instructions to stop the preload process responsive to a determination that the idle period has ended.

11. The medium of claim 10, including instructions to resume the preload process responsive to a determination of a subsequent idle period during the subsequent session.

12. The medium of claim 11, including instructions to complete an entirety of the preload process during the subsequent idle period.

13. (canceled)

14. The medium of claim 8, including instructions not to initiate the preload process during the idle period responsive to a determination of a particular connection type associated with the subsequent session.

15. A system, comprising:
a processor; and
a memory having instructions stored thereon which, when executed by the processor, cause the processor to:
receive a plurality of telemetry events corresponding to a plurality of sessions with an application, wherein the application includes a perpetually visible navigation pane that includes a plurality of user interface elements, and a details pane configured to display information corresponding to a selected one of the plurality of user interface elements of the navigation pane, wherein each telemetry event is associated with a user selection of any of the plurality of user interface elements of the navigation pane that causes one of a plurality of chunks of executable instructions of the application to load;
determine, based on the plurality of telemetry events, a respective probability associated with each of the plurality of chunks being loaded in a subsequent session;
determine an idle period during the subsequent session; and
initiate a preload process during the idle period, wherein the preload process includes preloading all of the plurality of chunks of executable instructions of the application in an order of descending determined probability irrespective of whether any of the plurality of user interface elements are currently visible on a display device.

16. The system of claim 15, including instructions to determine a type of a connection associated with the subsequent session.

17. The system of claim 16, wherein the instructions to initiate the preload process include instructions to:
initiate the preload process responsive to a determination of a first connection type; and
not initiate the preload process responsive to a determination of a second connection type.

18. The system of claim 15, wherein at least one of the plurality of chunks is a file.

19. The system of claim 15, wherein at least one of the plurality of chunks is associated with a dialog box.

20. The system of claim 19, wherein the plurality of user interface elements correspond to objects of a software defined data center.
